(19) United States
(12) Patent Application Publication
(10) Pub. No.: US 2026/0349751 A1
(43) Pub. Date: Nov. 5, 2026

(54) THOE.ai: A MULTI-DIMENSIONAL OPERATING ENVIRONMENT FOR THE THOE UNIVERSE FEATURING THOE PRISM OPTICAL ORCHESTRATION, CROSS-TIMELINE FUNCTIONAL PERSISTENCE, SOVEREIGN DATA SHIELDING, THE THOE MUSIC PLAYER WITH 6-SERVICE AGGREGATION AND CONTINUOUS CROSS-ERA PLAYBACK, AND AN AUTOMATED 25-SOCIAL MEDIA PLATFORM UPLOADER

(71) Applicant: Treena Katrice Edwards, Louisa, VA (US)

(72) Inventor: Treena Katrice Edwards, Louisa, VA (US)

(21) Appl. No.: 19/667,676

(22) Filed: May 5, 2026

Related U.S. Application Data
(60) Provisional application No. 63/799,792, filed on May 5, 2025.

(51) Int. Cl. G06F 9/445

(52) U.S. Cl. CPC G06F 9/4451

(57) ABSTRACT

A system and method for a multi-dimensional operating environment (THOE.ai) providing digital sovereignty within a THOE Universe. The system features a THOE Prism engine for seamless transitions between distinct visual timelines without interrupting a persistent THOE Music Player that aggregates six streaming services for continuous media play. It includes an automated auto-uploader for twenty-five social media platform nodes, a “Sovereign Shield” for local data protection, and a user-architected interface where UI elements respond to user presence with kinetic-to-static state shifts and photochromic illumination.

### CROSS-REFERENCE TO RELATED APPLICATIONS

This application claims priority to U.S. Provisional Application No. 63/799,792, filed May 5, 2025, which is incorporated herein by reference in its entirety.

### BACKGROUND OF THE INVENTION

In the current digital landscape, users are trapped in “flat,” static realities owned by centralized platforms. These platforms act as gatekeepers, forcing users to surrender their data sovereignty to exist online. Furthermore, modern interfaces are rigid—they do not allow a user to transition between different “Timelines” or “Eras” without breaking the continuity of their experience, especially regarding media playback. Managing a presence across a registry of twenty-five different platforms is currently a fragmented process that exposes user privacy. There is a critical need for a platform like THOE.ai that functions as a portal to a THOE Universe, where the user remains the central hero and owner of their own digital dimensions.

### SUMMARY OF THE INVENTION

The present invention, THOE.ai, is a multi-dimensional operating system that orchestrates the THOE Universe. It is designed to act as a Sovereign Shield for the user, utilizing a THOE Prism engine to manage the “vibrational frequency” of the user interface. This allows the user to jump between distinct timelines—such as the high-tech “Grid” or the frosted “Ethereal” dimension—while maintaining a persistent state across all realities.

Key to the THOE Universe is the ability to project content across twenty-five different social media platform nodes simultaneously via an integrated auto-uploader. The system further includes the THOE Music Player, a persistent media deck aggregating six distinct music streaming services into a single interface. This player is engineered for “Dimensional Continuity,” ensuring that music remains in a state of continuous play without interruption even as the user transitions the entire environment through various visual Eras.

### BRIEF DESCRIPTION OF THE SEVERAL VIEWS OF THE DRAWINGS

FIG. 1 is a screenshot of the THOE.ai Command Center, showing the 25-social media platform uploader registry and the gateway to the THOE Universe.

FIG. 2 is a screenshot of the Sovereign Shield settings, illustrating the quantum-resistant protection of the user's personal data vault.

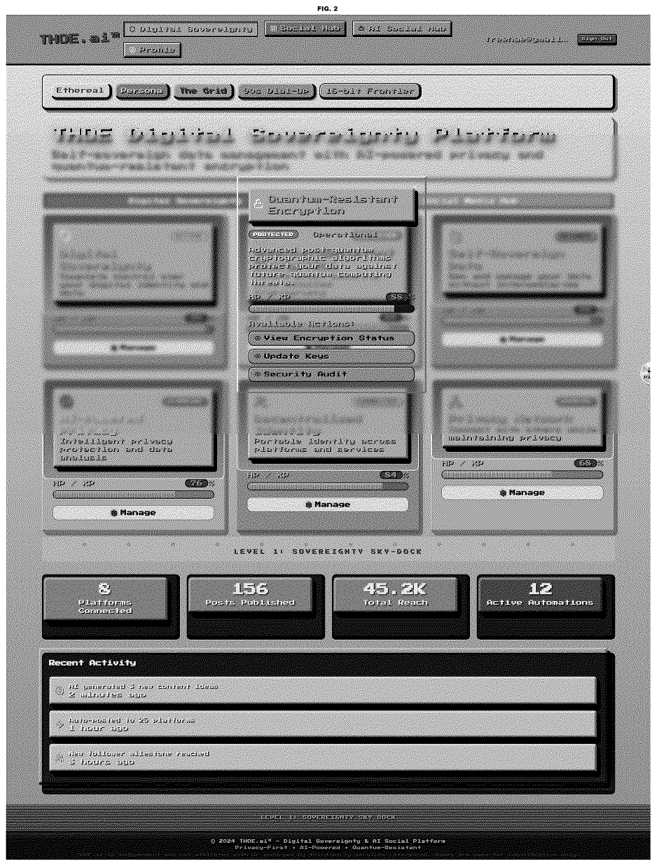

FIG. 3 is a screenshot of the encryption page showing the future-proof cryptographic status of the THOE Universe.

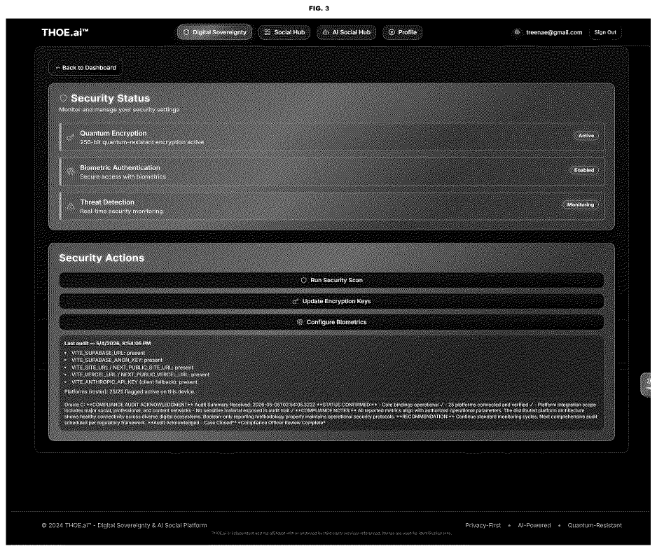

FIG. 4 is a screenshot of the Ethereal Timeline, illustrating the THOE Glass architecture and the THOE Prism light-shifting effects.

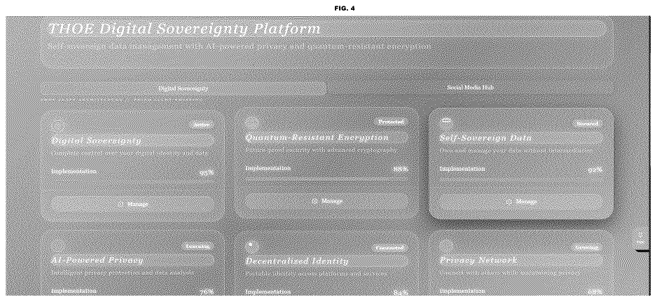

FIG. 5 is a screenshot of the auto-uploader tool showing the automated relay status for the 25-platform registry.

FIG. 6 is a screenshot of the Persona Platform interface, illustrating the user-architected layout and the “Alive” UI elements that respond to the user.

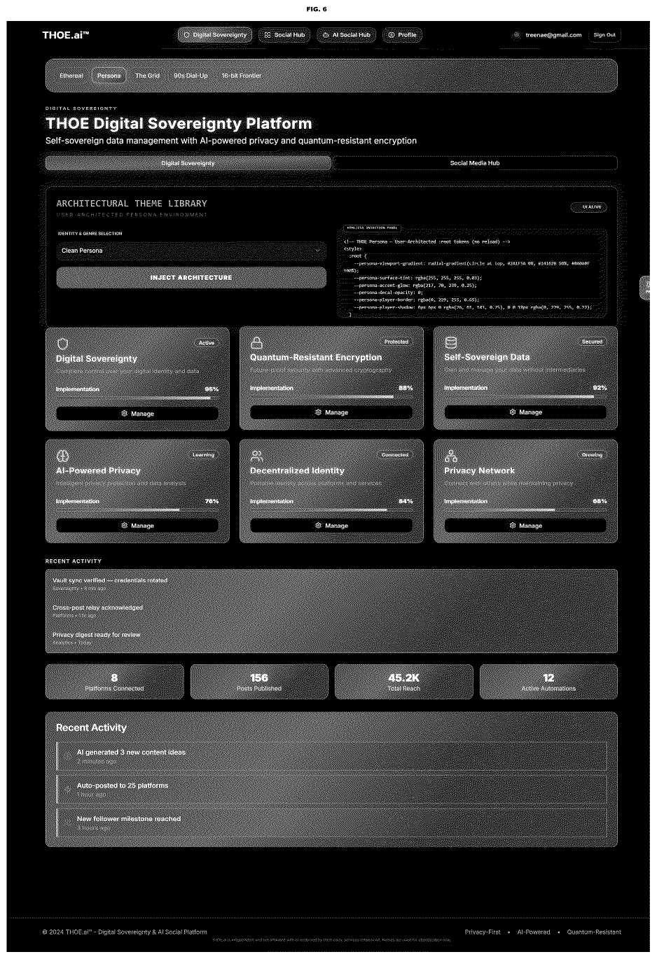

FIG. 7 is a screenshot of the account settings and the decentralized identity (DID) wallet.

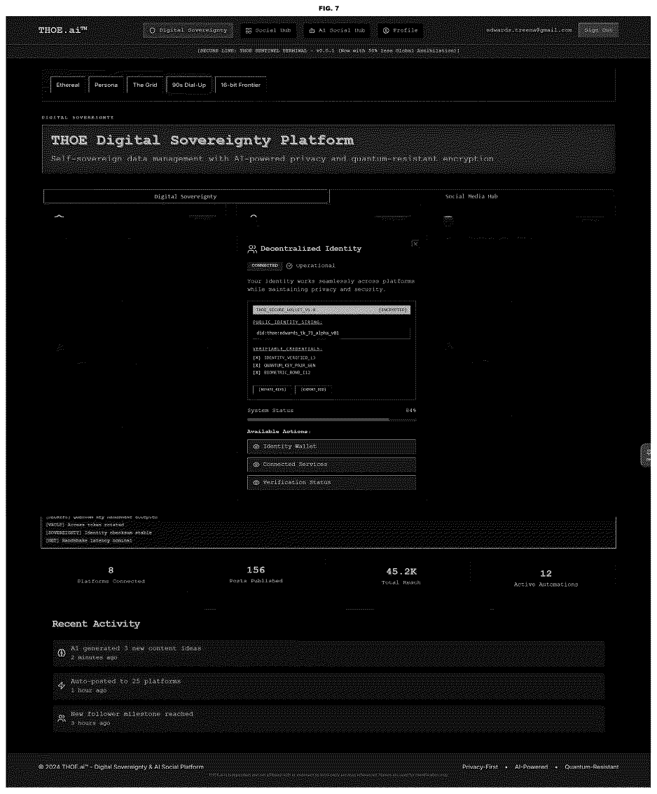

FIG. 8 is a screenshot of the THOE Music Player, illustrating the continuous playback of aggregated streams from six services across different visual timelines.

FIG. 8A is a screenshot of the THOE Music Player showing the first few streaming services in the lineup.

FIG. 8B is a screenshot showing the rest of the 6-service list after scrolling down, proving it is a full multi-source deck.

FIG. 8C is a screenshot of the THOE Music Player “Pinned” in place while the user is in the Ethereal timeline.

FIG. 8D is a screenshot showing the player “Unpinned” and tucked away, proving the user can clear the workspace without interrupting audio continuity.

FIG. 8E is a screenshot of the THOE Music Player locked into the Ethereal Timeline, showing the player's vibrational frequency matching the frosted dimension.

FIG. 8F is a screenshot of the exact same THOE Music Player after a “Dimensional Jump” into The Grid, proving the music maintains continuous play despite the shift in visual reality.

FIG. 8G is a screenshot showing the player in a hidden state, illustrating how the soundtrack continues to play in the background.

FIG. 9 is a side-by-side comparison showing a THOE Prism element in its kinetic “floating” state versus its illuminated “hover” state.

FIG. 10 is a screenshot of the Ethereal Era, showing the frosted THOE Glass effect and soft, glowing light orchestration.

FIG. 11 is a screenshot of the Persona Era, showing the user-architected layout with custom modular assembly.

FIG. 12 is a screenshot of The Grid, illustrating a high-contrast, deep-space digital environment with neon accents.

FIG. 13 is a screenshot of the 90s Dial-Up Era, showing a retro-computational aesthetic.

FIG. 14 is a screenshot of the 16-bit Frontier, illustrating a pixel-refined, classic gaming-inspired visual dimension.

### DETAILED DESCRIPTION OF THE INVENTION

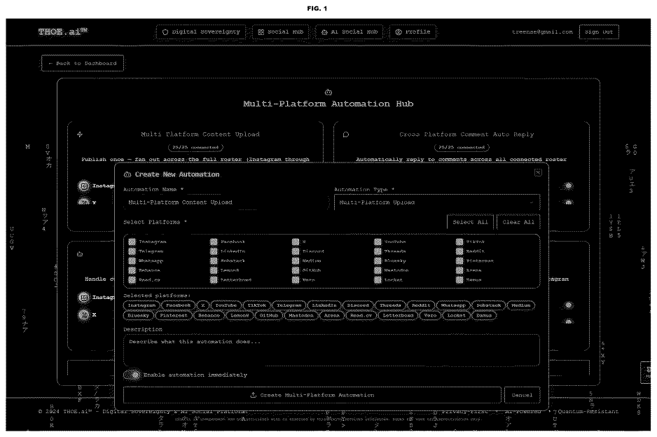

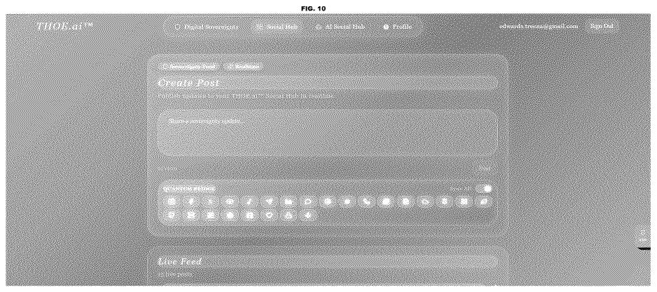

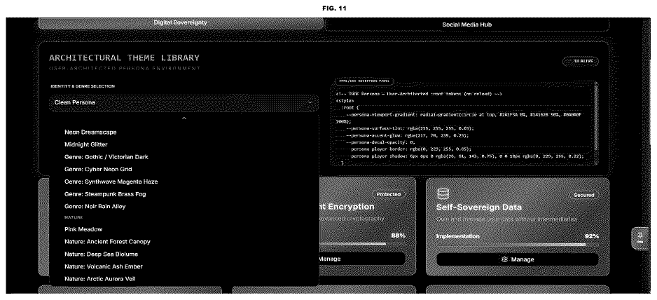

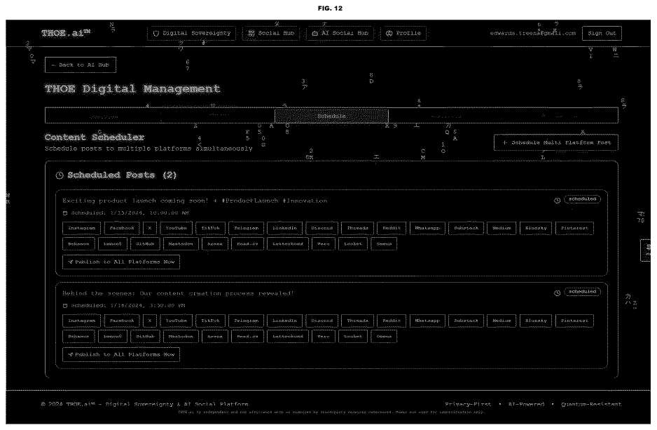

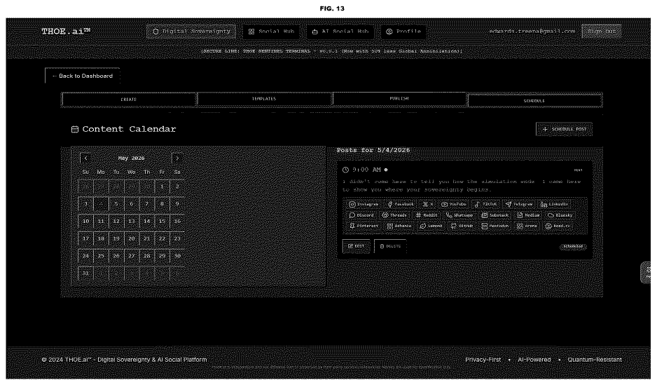

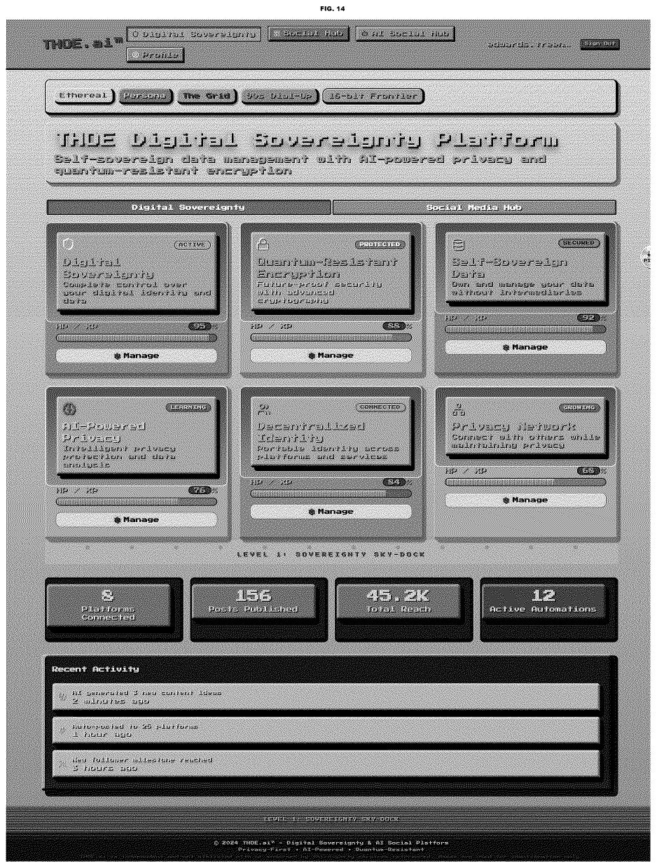

The THOE Universe Multiverse Logic: As shown in FIG. 1, THOE.ai (pronounced THOH-EE, rhymes with Zoe) serves as the primary portal into a multi-dimensional digital experience. The system allows users to shift their entire operational environment between different “Timelines” or “Eras.” As illustrated across FIGS. 10 through 14, when a user initiates a “Jump” between these timelines—moving from the Ethereal to The Grid or the 16-bit Frontier—the THOE Prism engine recalculates the visual physics of the screen. This involves adjusting light, transparency, and motion to reflect the new reality without interrupting the user's active work or background processes.

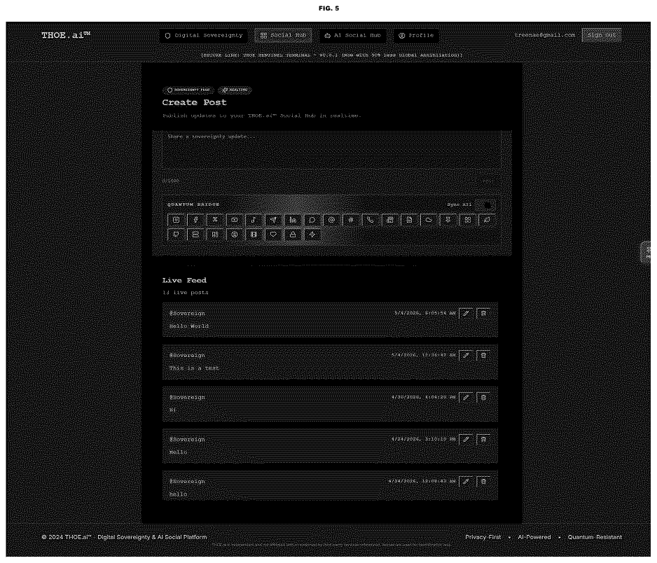

Automated 25-Platform Projection: To ensure the user's presence is felt across the wider digital multiverse, THOE.ai includes an automated projection engine. As depicted in FIGS. 1 and 5, this engine normalizes and secures a single piece of content and broadcasts it to a registry of twenty-five different social media platform nodes. This allows the user to remain “Incognito” within their own sovereign home base while maintaining a massive reach across the external digital landscape.

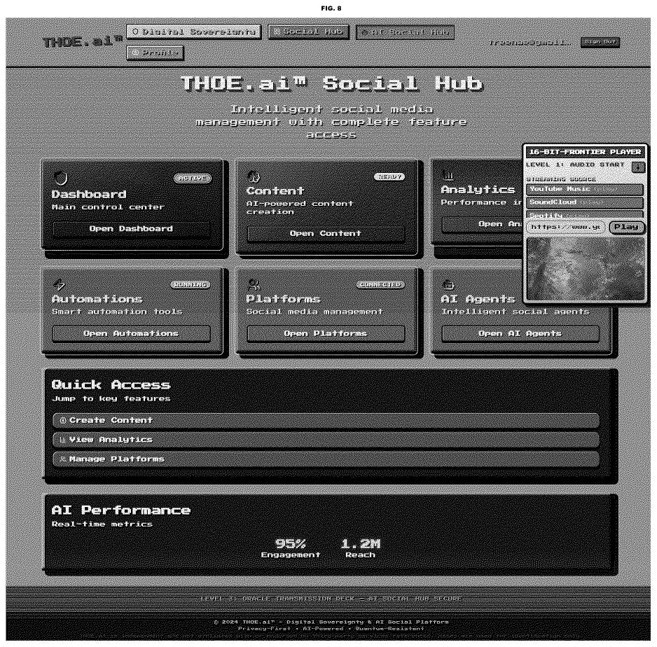

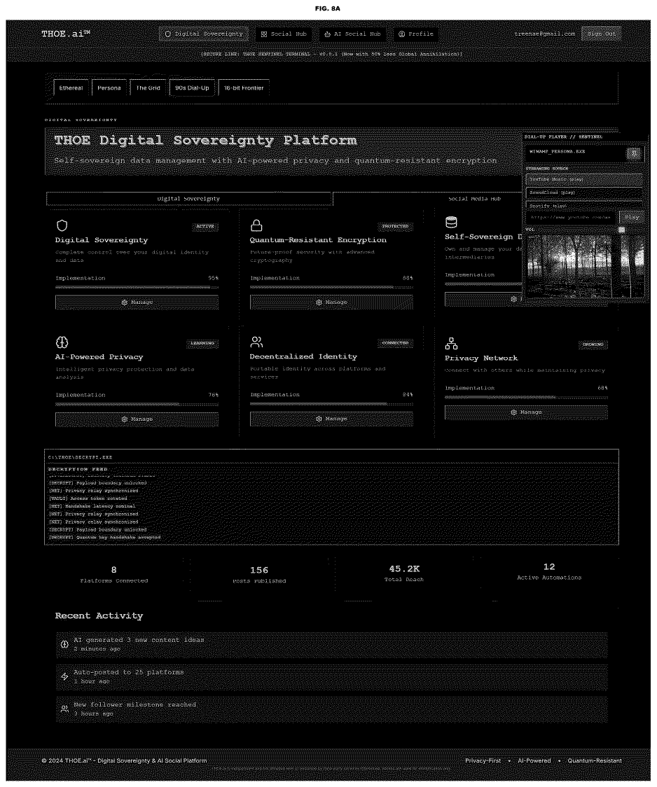

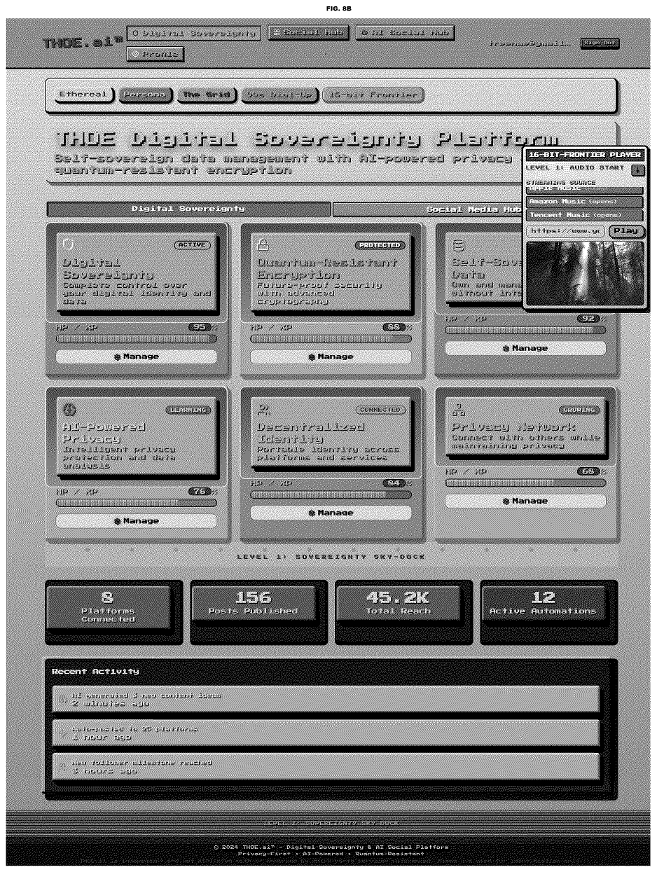

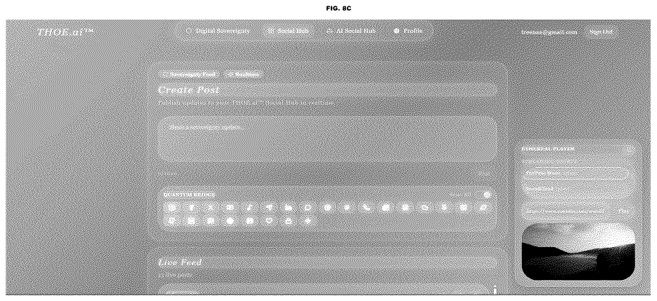

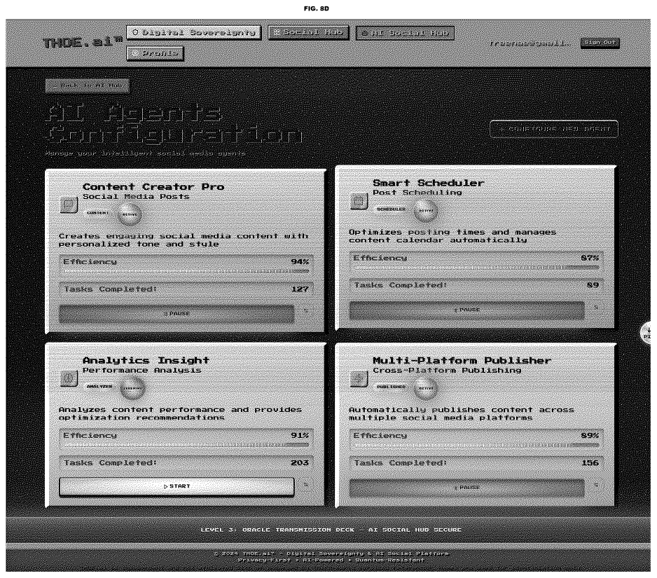

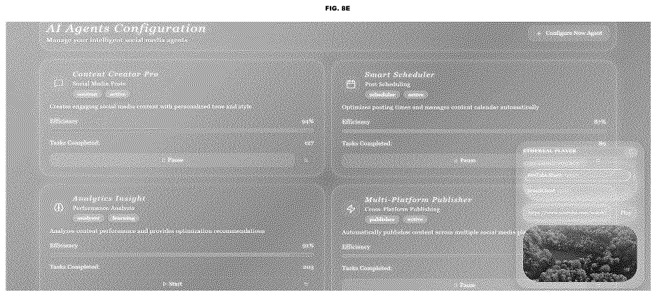

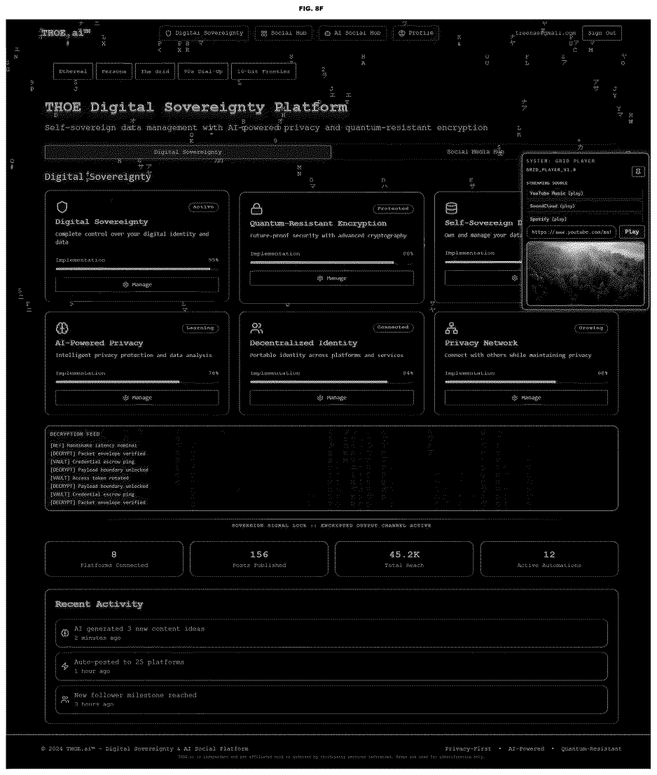

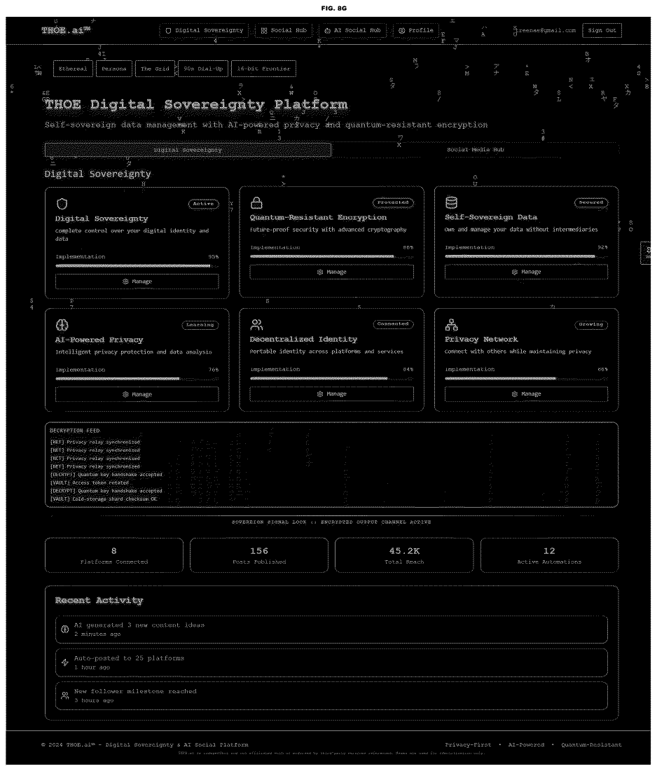

The THOE Music Player & Dimensional Continuity: As illustrated in FIGS. 8 through 8B, the invention includes the THOE Music Player. This component is engineered to aggregate six distinct streaming services—YouTube Music, SoundCloud, Spotify, Apple Music, Amazon Music, and Tencent—into a single, sovereign shell. A primary technical advantage of this player is its “Cross-Era Persistence.” Whether the user is navigating the Ethereal, The Grid, Persona, 90s Dial-Up, or 16-bit Frontier eras, the THOE Music Player maintains a state of continuous playback. As shown by comparing FIGS. 8E and 8F, the audio environment is never broken by changes in the UI's visual frequency or coordinate shifts.

Workspace Spatial Management: The system provides the user with total control over their digital sanctuary. As shown in FIGS. 8C, 8D, and 8G, the THOE Music Player includes a “Pin/Unpin” feature. Users can lock the player into their current timeline or “unpin” it to clear the workspace. Even when tucked away or invisible, the player remains active in the background, ensuring the soundtrack follows the user through every dimension.

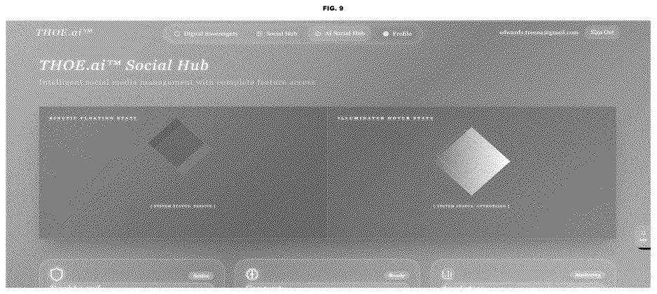

THOE Prism Signature Interaction: A signature feature of the THOE Universe is that the interface feels “alive” and responsive. As illustrated in the side-by-side comparison in FIG. 9, interactive elements exist in a kinetic state, gently floating within the UI. Using THOE Prism logic, when a user hovers over an element, it undergoes a “Photochromic Shift.” The element stops moving (becoming static) and illuminates, providing a visual confirmation of a secure and responsive connection between the user and the platform.

What is claimed is:

1. A multi-dimensional operating environment (THOE.ai) for digital sovereignty, comprising: (a) a sovereign shield layer for local data protection; (b) a chromatic engine (THOE Prism) that shifts a user interface between multiple visual timelines; (c) an auto-uploader that automatically projects content across twenty-five different social media platform nodes; and (d) a persistent THOE Music Player aggregating six streaming services and providing continuous play during transitions between visual eras.

2. The system of claim 1, wherein the THOE Prism engine utilizes photochromism to illuminate floating interface elements in response to user interaction.

3. The system of claim 1, wherein shifting between timelines maintains a persistent, uninterrupted background state for the THOE Music Player.

4. A method for managing a THOE Universe digital identity, comprising: (a) anchoring a user in a sovereign THOE.ai environment; (b) transitioning the environment's visual frequency through THOE Prism logic; and (c) broadcasting secured metadata to twenty-five social media platform nodes via an automated projection engine.
